(19) United States
(12) Patent Application Publication
(10) Pub. No.: US 2017/0094566 A1
(43) Pub. Date: Mar. 30, 2017

(54) MEASUREMENT REPORTING THRESHOLD CONFIGURATION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/866,820

(22) Filed: Sep. 25, 2015

(51) Int. Cl. H04W 36/00; H04W 36/04; H04W 36/30

(52) U.S. Cl. CPC H04W 36/0061; H04W 36/0094; H04W 36/30; H04W 36/04

(57) ABSTRACT

In one instance, a base station configures a first set of UEs, served by a serving base station, with a first IRAT measurement reporting threshold (inter-radio access technology measurement reporting threshold). The base station also configures a second set of UEs, served at the serving base station, with a second IRAT measurement reporting threshold that differs from the first IRAT measurement reporting threshold when a number of UEs served by the serving base station exceeds a congestion threshold.

### BACKGROUND

Field

Aspects of the present disclosure relate generally to wireless communication systems, and more particularly, to configuring measurement report settings for multiple user equipments (UEs).

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes configuring a first set of UEs (user equipments), served by a serving base station, with a first IRAT measurement reporting threshold (inter-radio access technology measurement reporting threshold). The method also includes configuring a second set of UEs, served by the serving base station, with a second IRAT measurement reporting threshold that differs from the first IRAT measurement reporting threshold when a number of UEs served by the serving base station exceed a congestion threshold. The congestion threshold, the first IRAT measurement reporting threshold and/or the second IRAT measurement reporting threshold being based on a capability of at least one target base station of a target RAT supporting one or more potential target cells to handle incoming IRAT handovers.

According to another aspect of the present disclosure, an apparatus for wireless communication includes means for configuring a first set of UEs (user equipments), served by a serving base station, with a first IRAT measurement reporting threshold (inter-radio access technology measurement reporting threshold). The apparatus may also include means for configuring a second set of UEs, served by the serving base station, with a second IRAT measurement reporting threshold that differs from the first IRAT measurement reporting threshold when a number of UEs served by the serving base station exceed a congestion threshold. The congestion threshold, the first IRAT measurement reporting threshold and/or the second IRAT measurement reporting threshold being based on a capability of at least one target base station of a target RAT supporting one or more potential target cells to handle incoming IRAT handovers.

Another aspect discloses an apparatus for wireless communication and includes a memory and one or more processors (e.g., at least one processor) coupled to the memory. The processor(s) is configured to configure a first set of UEs (user equipments), served by a serving base station, with a first IRAT measurement reporting threshold (inter-radio access technology measurement reporting threshold). The processor(s) is also configured to configure a second set of UEs, served by the serving base station, with a second IRAT measurement reporting threshold that differs from the first IRAT measurement reporting threshold when a number of UEs served by the serving base station exceed a congestion threshold. The congestion threshold, the first IRAT measurement reporting threshold and/or the second IRAT measurement reporting threshold being based on a capability of at least one target base station of a target RAT supporting one or more potential target cells to handle incoming IRAT handovers.

Yet another aspect discloses a computer program product for wireless communications in a wireless network having a non-transitory computer-readable medium. The computer-readable medium has non-transitory program code recorded thereon which, when executed by the processor(s), causes the processor(s) to configure a first set of UEs (user equipments), served by a serving base station, with a first IRAT measurement reporting threshold (inter-radio access technology measurement reporting threshold). The program code also causes the processor(s) to configure a second set of UEs, served by the serving base station, with a second IRAT measurement reporting threshold that differs from the first IRAT measurement reporting threshold when a number of UEs served by the serving base station exceed a congestion threshold. The congestion threshold, the first IRAT measurement reporting threshold and/or the second IRAT measurement reporting threshold being based on a capability of at least one target base station of a target RAT supporting one or more potential target cells to handle incoming IRAT handovers.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a diagram illustrating network coverage areas according to aspects of the present disclosure.

FIG. 7 illustrates a network utilizing multiple types of radio access technologies (RATs) according to aspects of the present disclosure.

FIG. 8 is a graph illustrating tiered inter-radio access technology measurement reporting thresholds for multiple UEs.

FIG. 9 is a flow diagram illustrating a method for configuring inter-radio access technology measurement reporting thresholds for multiple user equipments according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

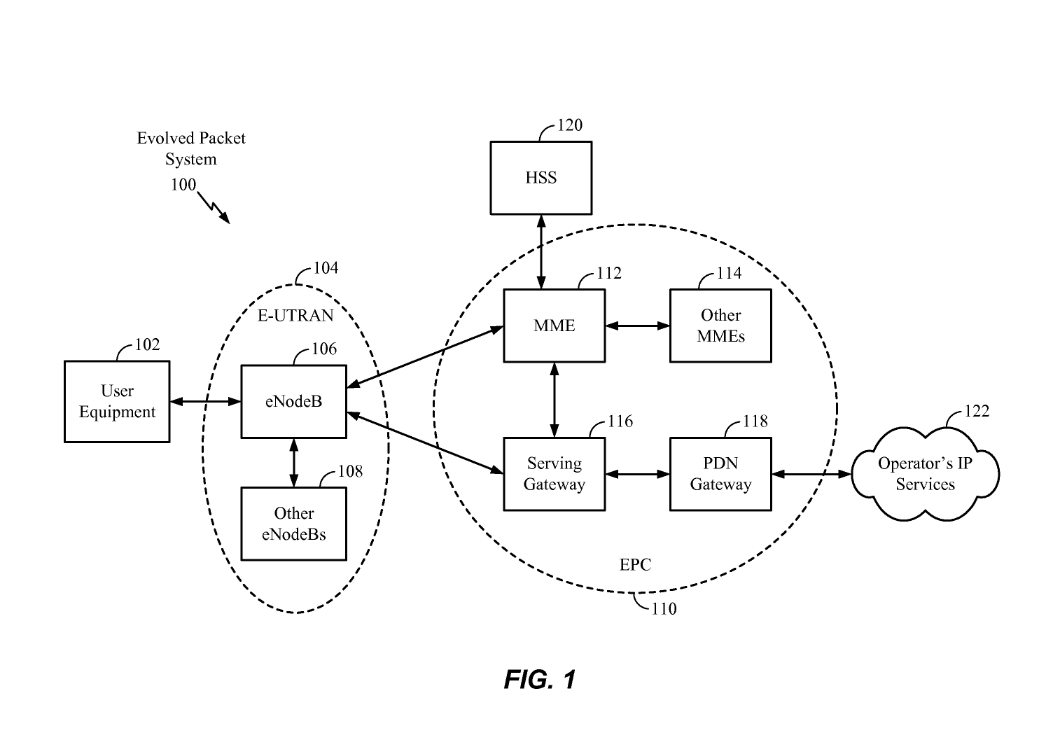

FIG. 1 is a diagram illustrating a network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

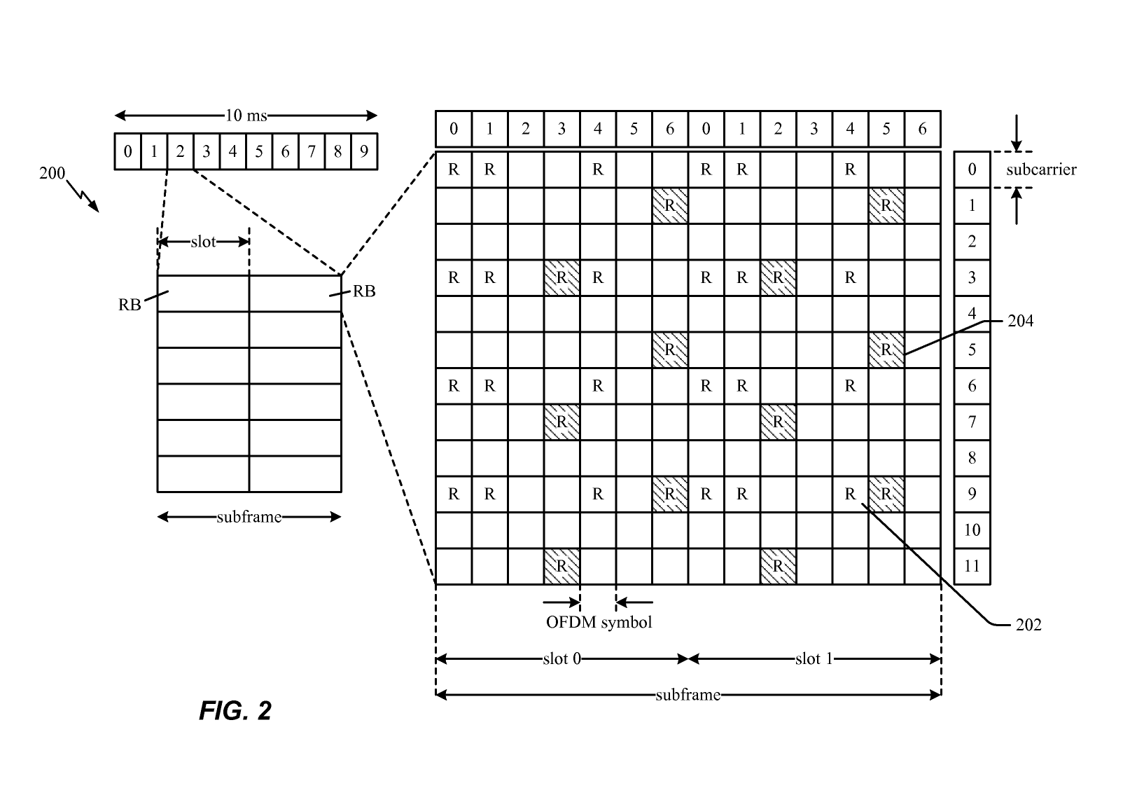

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

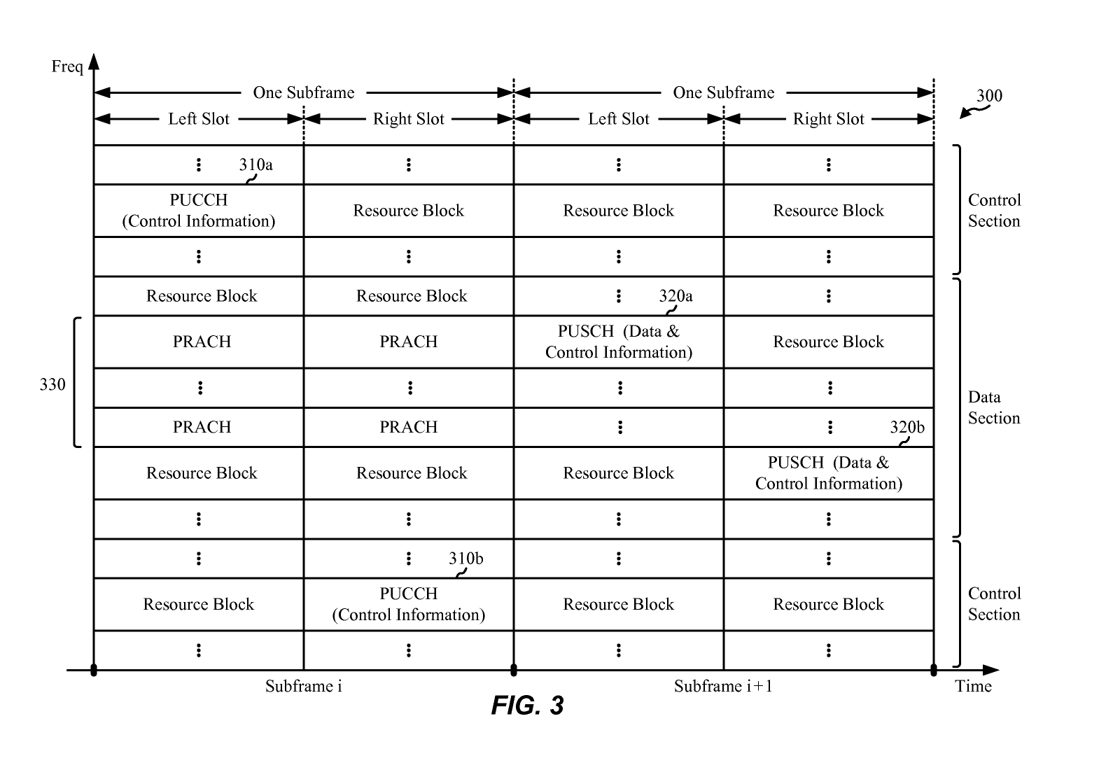

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

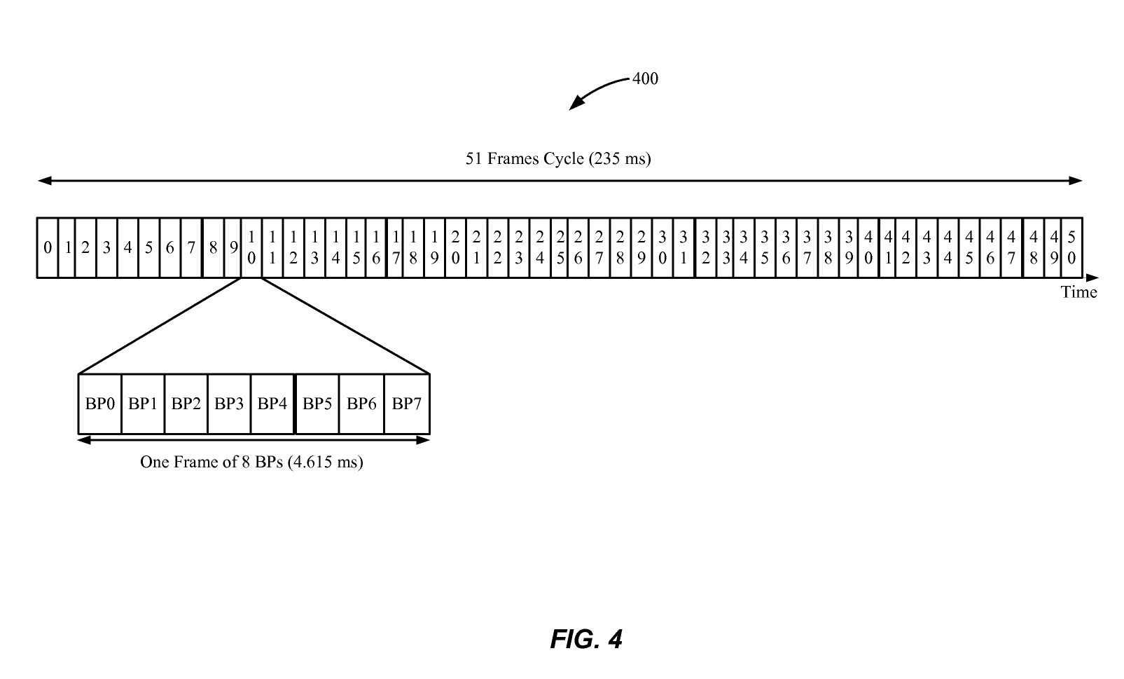

FIG. 4 is a block diagram illustrating an example of a GSM frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

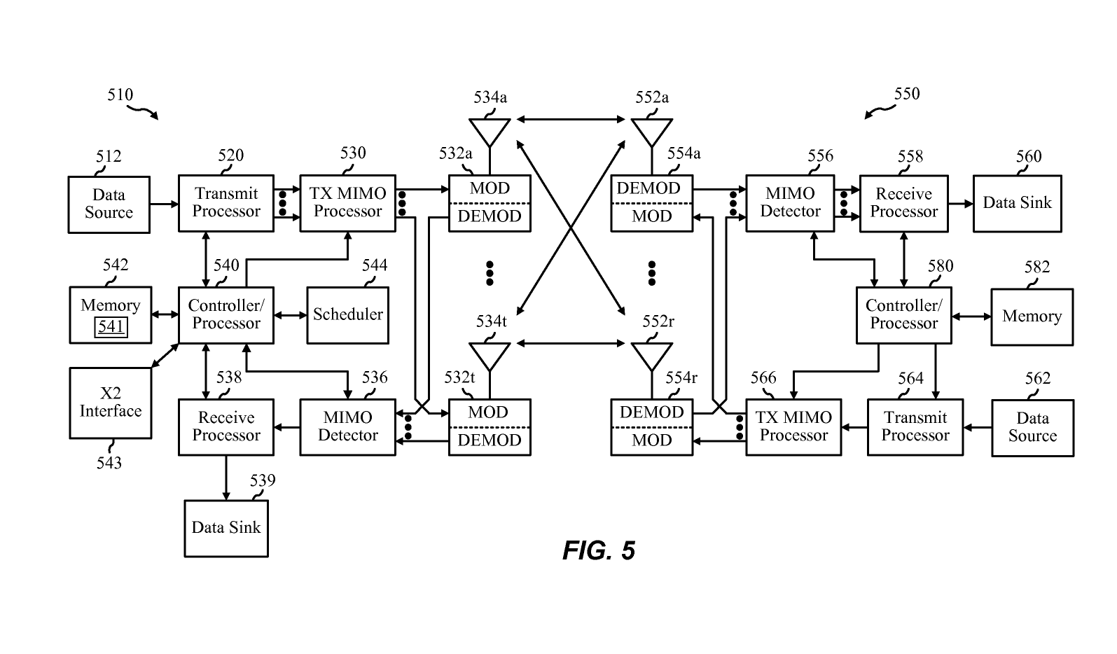

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The processor 520 may process (e.g., encode and symbol map) the data and control information to obtain data symbols and control symbols, respectively. The processor 520 may also generate reference symbols. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for single carrier-frequency division multiple access (SC-FDMA), etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 543.

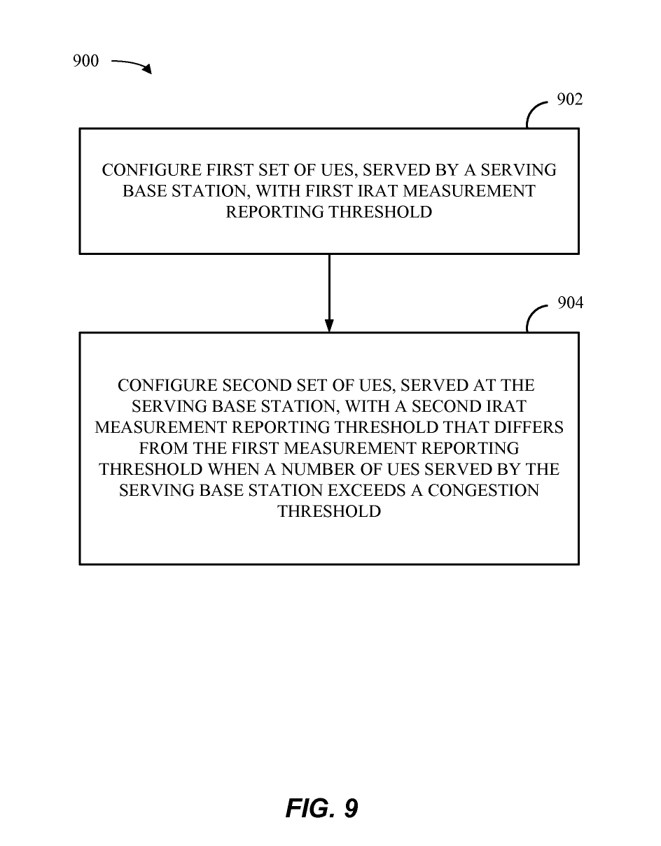

The controllers/processors 540 and 580 may direct the operation at the base station 510 and the UE 550, respectively. The processor 540/580 and/or other processors and modules at the base station 510/UE 550 may perform or direct the execution of the functional blocks illustrated in FIG. 9, and/or other processes for the techniques described herein. For example, the memory 542 of the base station 510 may store a threshold configuration module 541 which, when executed by the controller/processor 540, configures the base station 510 to configure multiple UEs 550 with inter-radio access technology measurement reporting thresholds according to one aspect of the present disclosure. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an ACK and/or NACK protocol to support HARQ operations.

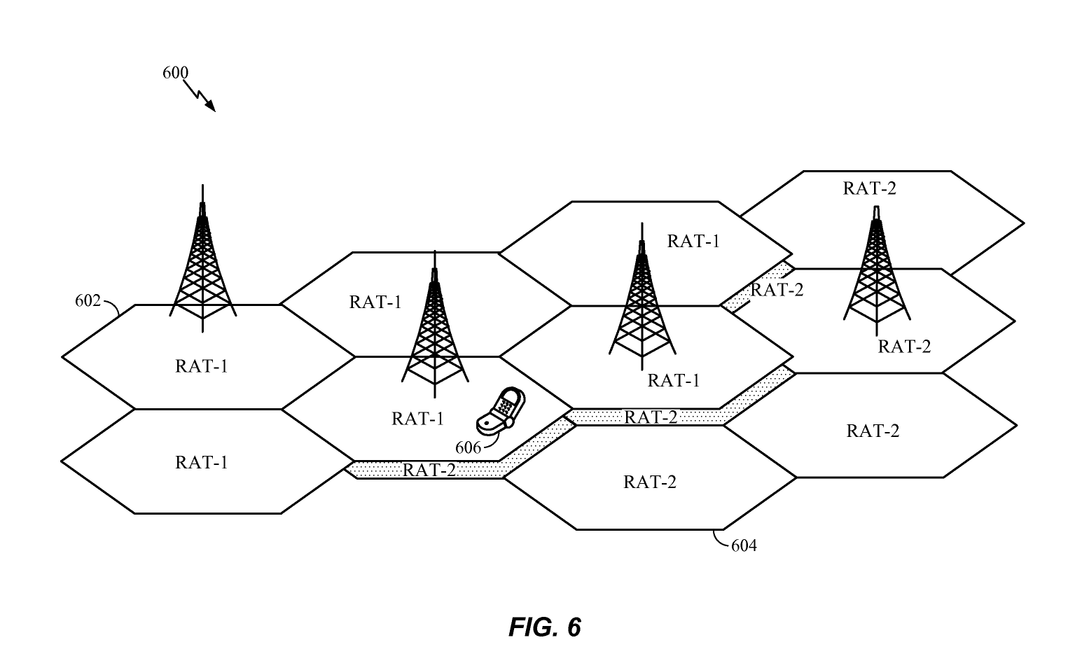

Some networks may be deployed with multiple radio access technologies. FIG. 6 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 600 includes RAT-1 cells 602 and RAT-2 cells 604. In one example, the RAT-1 cells are LTE cells and the RAT-2 cells are 2G or 3G cells. However, those skilled in the art will appreciate that other types of radio access technologies may be utilized within the cells. A user equipment (UE) 606 may move from one cell, such as a RAT-1 cell 602, to another cell, such as a RAT-2 cell 604. The movement of the UE 606 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., LTE) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor becomes better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter-frequency measurements.

The measurement gap may be used for multiple IRAT measurements and inter-frequency measurements. The inter-frequency measurements may include measurements of frequencies of a same RAT (e.g., serving LTE). The IRAT measurements may include measurements of frequencies of a different RAT (e.g., non-serving RAT such as wideband code division multiple access (WCDMA) or GSM). In some implementations, the LTE inter-frequency measurements and WCDMA IRAT measurements have a higher measurement scheduling priority than GSM.

A UE may perform a serving cell measurement of a serving RAT (e.g., LTE). When a signal quality of the serving cell is below a threshold (meaning the serving cell signal may not be sufficient for an ongoing call), the UE may send an event 2A report (e.g., measurement report) to a serving base station supporting the serving cell. A change in the signal quality of the serving cell may occur when the UE leaves a coverage area of the serving cell. For example, when a high speed train leaves LTE coverage (e.g., at a coverage boundary), all of the UEs (e.g., voice over LTE UEs) in the high speed train may send measurement reports at the same time. Sending the measurement reports at the same time causes long latency of inter-radio access technology (IRAT) configuration and handover (e.g., enhanced single radio voice call continuity (eSRVCC) handover) preparation time. The latency may be due to congestion on the target RAT resulting from all the UEs attempting to connect at the same time. The latency may eventually result in call drop before the handover.

### Measurement Reporting Threshold Configuration

Aspects of the present disclosure are directed to reducing call drop when multiple user equipments (UEs) are sending measurement reports at the same time to one or more serving base stations supporting one or more cells on which the UEs are camped. For example, the one or more serving base stations that support one or more cells of a first or serving radio access technology (RAT (e.g., LTE)) configure multiple measurement report settings for UEs when the UEs approach a coverage boundary of the one or more cells of the first RAT. In some aspects the measurement reports settings are configured based on a UE being in a state of travelling at high speed. The network may know the UE is in a high speed state because the network can measure the UE Doppler frequency based on the uplink signal transmitted from the UE, such as the demodulation reference signal (DM-RS), and sounding reference signal (SRS).

In one aspect of the present disclosure, the configuration of the measurement report settings for the multiple UEs is based on a number of the UEs being served by the one or more cells. For example, a number of UEs in a high speed train supported by the one or more cells may be compared to a congestion threshold (e.g., 50 UEs=congestion threshold). In an aspect of the disclosure, the congestion threshold can be based on a capability of one or more target cells of a target RAT (e.g., GSM) for handling incoming inter radio access technology (IRAT) handover of the UEs. For example, the base station may determine that 500 UEs are too many to service at the same time. Although a high speed train is provided as an example, the present disclosure contemplates other high speed scenarios, such as travelling on a freeway or inside a drone.

For example, when the number of UEs (e.g., 10 UEs) is below the congestion threshold (e.g., 50 UEs), the measurement report settings are configured the same for all of the UEs, through dedicated signaling messages. However, when the number of UEs (e.g., 100 UEs) is above the congestion threshold, different measurement report settings are defined for different sets of UEs. The measurement report settings for each set can be based on a category of each of the UEs in the set. For example, the UEs may be categorized as very important person (VIP) UEs or non-VIP UEs. Alternatively, the UE category can be based on the uplink and downlink capacity of the UE. The base station may also define a first set of UEs and a second set of UEs based on a quality of service (QOS) profile of the UEs. For example, some UEs may have stricter latency specifications than others and therefore handover of such UEs with stricter latency specification may be expedited. The measurement report settings may be configured to expedite handover or cell reselection for the UEs with the stricter latency specifications. All UEs will be classified into only one of the sets. The sets may be predefined.

The measurement settings may include signal quality threshold values such as IRAT measurement reporting thresholds. Cells of the first RAT supporting a high speed train near a coverage boundary may configure measurement report settings with different signal quality threshold values for each of the UEs in the high speed train based on the category of the UEs. The threshold values may be signal quality threshold values of the serving cell that indicate when a particular UE should start performing and reporting results of the measurements in the measurement report. For example, a serving base station configures a first set of UEs with a first signal quality threshold value. The base station may also configure a second set of UEs with a second signal quality threshold value that differs from the first signal quality threshold value.

By using different thresholds, some UEs can be handed over to the target RAT (e.g., GSM) in advance, even when the serving cell (e.g., LTE) signal quality is good. The different thresholds effectively avoid congestion due to increased measurement reporting to the serving RAT and increased processing by the target RAT due to the large number of UEs requesting handover. Further, using different thresholds may cause the measurement reports for the different UEs to include different target cells for handover.

In some aspects of the disclosure, the first set and the second set of UEs and/or the corresponding settings for the different sets may be defined based on concurrent services running on the UEs. For example, the serving base station defines the first set of UEs based on concurrent voice services running on the UEs and defines the second set of UEs based on concurrent data services running on the UEs. Concurrent services mean that multiple services are running at a same time on a UE, for example video telephony service including video and voice service simultaneously. Further, a first signal quality threshold value may be configured for UEs running a service with a higher priority. A second signal quality threshold value may be configured for UEs running a service with a lower priority.

In yet another aspect of the disclosure, the first set and the second set of UEs and/or the corresponding settings for the different sets are defined based on whether the target RAT supports a service running on each of the UEs. For example, the first set and the second set of UEs are defined based on whether the target RAT supports all or partial concurrent services running on the UEs. In some configurations, the UE could hand over to multiple RATs, such as 2G or 3G.

The base station may also define the different sets of UEs and their corresponding settings based on connection setup or call/connection status of a communication on the UEs. For example, the status of communication includes connected mode where the call setup is completed, an idle mode and a connected mode with ongoing call setup. Other call statuses include connected mode during call setup with both the UE and the network supporting IRAT handover at a stage of the call setup and connected mode during call setup where the UE or the network does not support IRAT handover at the stage of the call setup. The thresholds are set and allocated based on the status of each set of the UEs. For example, the connected mode UEs where call setup is complete may have a high threshold, the idle mode UEs may have a low threshold and the connected mode UEs with ongoing call setup may have medium threshold. Further, the UE that are in connected mode during call setup with both the UE and the network supporting IRAT handover at the stage of the call setup may be allocated a medium threshold. Furthermore, the UEs that are in connected mode during call setup where the UE or the network does not support IRAT handover at the stage of the call setup may be allocated a lower threshold.

In a further aspect of the disclosure, a base station determines a number of sets of UEs based on a number of target cells neighboring the one or more serving cells or overlapping the one or more serving cells. In particular, the number of UEs in a first set of UEs and/or the number of UEs in a second set of UEs may be determined based on the number of potential target cells overlaid with at least one serving cell of the serving RAT. The number of UEs being served may be determined based on communication between base stations. For example, the number of UEs being served may be determined based on communication between target base stations. The threshold settings and the number of settings are then determined based on the number of UEs being served.

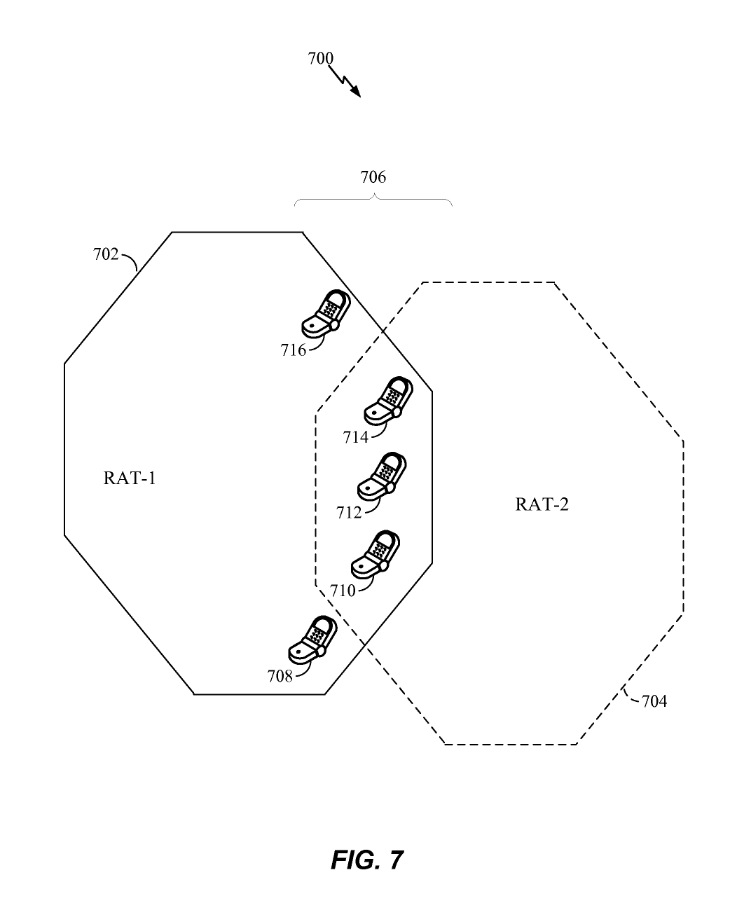

FIG. 7 illustrates a network 700 utilizing multiple types of radio access technologies (RATs) according to aspects of the present disclosure. For example, a geographical area of the network 700 includes RAT-1 cell 702 and RAT-2 cell 704. In one example, the RAT-1 cell 702 is an LTE cell and the RAT-2 cell 704 is a GSM cell. Multiple user equipments (UEs) 708, 710, 712, 714, 716 may move from one cell, such as the RAT-1 cell 702, to another cell, such as the RAT-2 cell 704. The movement of the UEs 708, 710, 712, 714, 716 may specify a handover or a cell reselection.

The handover or cell reselection may be performed when the UEs 708, 710, 712, 714, 716 move from a coverage area of the RAT-1 cell 702 to a coverage area of the RAT-2 cell 704. For example, handover or reselection may be performed when UEs 708, 710, 712, 714, 716 in a high speed train approach or enter a coverage boundary 706 of the RAT-1 cell. For example, the one or more serving base stations supporting the RAT-1 cell 702 configure measurement report settings for the multiple UEs 708, 710, 712, 714, 716 when the UEs approach the coverage boundary 706 of the RAT-1 cell 702.

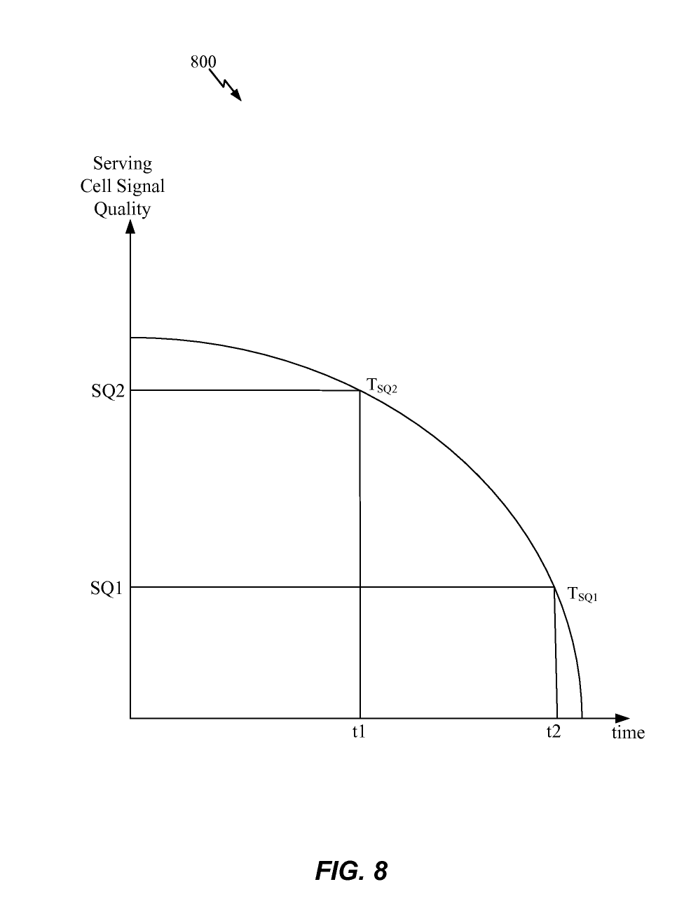

When a high speed train leaves or is about to leave the coverage boundary 706 of the RAT-1 cell 702, all of the UEs 708, 710, 712, 714, 716 in the high speed train may send measurement reports at the same time to the serving RAT-1 cell 702. Sending the measurement reports at the same time causes long latency of inter-radio access technology (IRAT) configuration and handover. To reduce the latency, the measurement settings may incorporate tiered inter-radio access technology measurement reporting thresholds for the multiple UEs 708, 710, 712, 714, 716, as shown in FIG. 8.

FIG. 8 is a graph 800 illustrating tiered inter-radio access technology measurement reporting thresholds for multiple UEs 708, 710, 712, 714, 716. The graph 800 illustrates signal quality of the serving cell (on the y-axis) with respect to time (x-axis). The measurement settings may include IRAT measurement reporting thresholds such as signal quality threshold values T_{SQ2} at time t1 and T_{SQ1} at time t2. Thus, the RAT-1 cell 702 supporting the high speed train (of FIG. 7) may configure measurement report settings with different signal quality threshold values T_{SQ2}, T_{SQ1} for different sets of the UEs in the high speed train based on the category of the UEs in the coverage boundary 706. For example, a first set of the UEs 708, 710, 712 may have measurement report settings corresponding to the signal quality threshold values T_{SQ2} and a second set of the UEs 714, 716 may have measurement report settings corresponding to the signal quality threshold values T_{SQ1}. By using different thresholds, some UEs can be handed over to the target RAT in advance (e.g., at time t1), even when the serving cell is good, to effectively avoid congestion due to increased measurement reporting. Although two thresholds are described, the disclosure is not so limited. Example thresholds may be −110 dBm and −105 dBm in an LTE network.

FIG. 9 is a flow diagram illustrating a method 900 for configuring inter-radio access technology measurement reporting thresholds for multiple user equipments (UEs) according to one aspect of the present disclosure. The method may reduce call drop when multiple user equipments (UEs) are sending measurement reports at the same time to one or more serving base stations supporting one or more cells on which the UEs are camped. At block 902, a serving base station of a network supporting the cells of a first or serving RAT (e.g., LTE) configure a first set of UEs, served by the serving base station, with a first IRAT measurement reporting threshold (inter-radio access technology measurement reporting threshold). For example, the controller/processor 540 of the serving base station 510 of FIG. 5 configures the first set of UEs with the first IRAT measurement reporting threshold. The configuration of the first set of UEs with the first IRAT measurement reporting threshold may occur when the UEs approach a coverage boundary of the one or more cells of the first RAT. At block 904, the serving base stations configure a second set of UEs, served at the serving base station, with a second IRAT measurement reporting threshold that differs from the first IRAT measurement reporting threshold when a number of UEs served by the serving base station exceed a congestion threshold. For example, the controller/processor 540 of the serving base station 510 of FIG. 5 configures the second set of UEs with the second IRAT measurement reporting threshold. The congestion threshold, the first IRAT measurement reporting threshold and/or the second IRAT measurement reporting threshold are based on a capability of one or more target base stations of a target RAT supporting one or more target cells to handle incoming IRAT handovers.

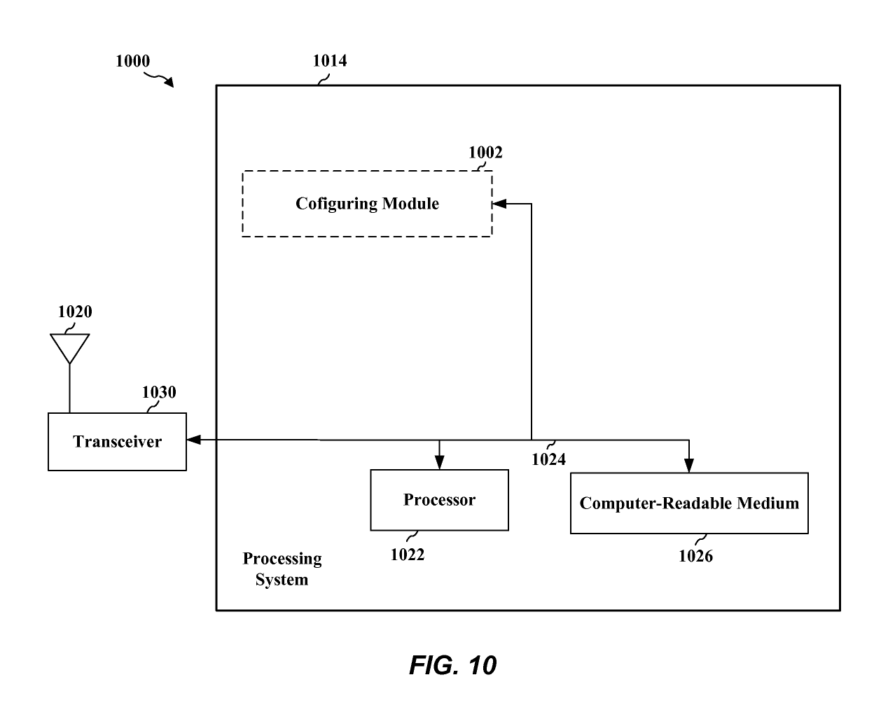

FIG. 10 is a diagram illustrating an example of a hardware implementation for an apparatus 1000 employing a processing system 1014 according to one aspect of the present disclosure. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, a configuring module 1002 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a configuring module 1002 for configuring a first set of UEs, served by a serving base station, with a first IRAT measurement reporting threshold. The configuring module 1002 also configures a second set of UEs, served by the serving base station, with a second IRAT measurement reporting threshold that differs from the first IRAT measurement reporting threshold when a number of UEs served by the serving base station exceed a congestion threshold. The configuring module 1002 may be software module(s) running in the processor 1022, resident/stored in the computer-readable medium 1026, one or more hardware modules coupled to the processor 1022, or some combination thereof. For example, when the configuring module 1002 is a hardware module, the configuring module 1002 includes the controller/processor 540 of FIG. 5. The processing system 1014 may be a component of the base station 510 of FIG. 5 and may include the memory 542, and/or the controller/processor 540.

In one configuration, an apparatus for wireless communication, such as a base station 510, includes means for configuring. In one aspect, the configuring means may be the controller/processor 540 of FIG. 5, the memory 542 of FIG. 5, the threshold configuration module 541 of FIG. 5, the configuring module 1002 of FIG. 10, the processor 1022 of FIG. 10 and/or the processing system 1014 of FIG. 10 configured to perform the aforementioned means. In one configuration, the means functions correspond to the aforementioned structures. In another aspect, the aforementioned means may be a module or any apparatus configured to perform the functions recited by the aforementioned means.

An apparatus, such as the base station 510, may be configured to include means for determining the number of UEs in a set. In one aspect, the determining means may be the controller/processor 540, the memory 542, and/or the processing system 1014 configured to perform the aforementioned means. Additionally, an apparatus, such as the base station 510, may be configured to include means for defining the set of UEs. In one aspect, the defining means may be the controller/processor 540, the memory 542, and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in frequency division duplex (FDD), time division duplex (TDD), or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
configuring a first set of UEs (user equipments), served by a serving base station, with a first IRAT measurement reporting threshold (inter-radio access technology measurement reporting threshold); and
configuring a second set of UEs, served at the serving base station, with a second IRAT measurement reporting threshold that differs from the first IRAT measurement reporting threshold when a number of UEs served by the serving base station exceeds a congestion threshold; the congestion threshold, the first IRAT measurement reporting threshold, and/or the second IRAT measurement reporting threshold being based at least in part on a capability of at least one target base station of a target RAT that supports at least one potential target cell to handle incoming IRAT handovers.

2. The method of claim 1, further comprising determining a number of UEs to include in the first set of UEs and/or a number of UEs to include in the second set of UEs based at least in part on a number of potential target cells overlaid with at least one serving cell of a serving RAT, wherein the serving base station supports the at least one serving cell.

3. The method of claim 1, further comprising defining the first set of UEs and the second set of UEs based at least in part on services running on the first set of UEs and the second set of UEs.

4. The method of claim 1, further comprising defining the first set of UEs and the second set of UEs based at least in part on a category of each of the UEs in the first set of UEs and each of the UEs in the second set of UEs.

5. The method of claim 1, further comprising defining the first set of UEs and the second set of UEs based at least in part on a quality of service (QoS) profile of the UEs in the first set of UEs and the second set of UEs or applications running on the UEs in the first set of UEs and the second set of UEs.

6. The method of claim 1, further comprising defining the first set of UEs and the second set of UEs based at least in part on whether the target RAT supports all or partial concurrent services running on the first set of UEs and the second set of UEs.

7. The method of claim 1, further comprising defining the first set of UEs and the second set of UEs based at least in part on a connection setup or connection status of the UEs in the first set of UEs and the second set of UEs.

8. The method of claim 1, further comprising determining the number of UEs that could be served by the target RAT based at least in part on communication between the serving base station and a potential target base station.

9. An apparatus for wireless communication, comprising:
means for configuring a first set of UEs (user equipments), served by a serving base station, with a first IRAT measurement reporting threshold (inter-radio access technology measurement reporting threshold); and
means for configuring a second set of UEs, served by the serving base station, with a second IRAT measurement reporting threshold that differs from the first IRAT measurement reporting threshold when a number of UEs served by the serving base station exceeds a congestion threshold; the congestion threshold, the first IRAT measurement reporting threshold and/or the second IRAT measurement reporting threshold being based at least in part on a capability of at least one target base station of a target RAT supporting at least one potential target cell to handle incoming IRAT handovers.

10. The apparatus of claim 9, further comprising means for determining the number of UEs to include in the first set of UEs and/or a number of UEs to include in the second set of UEs based at least in part on a number of potential target cells overlaid with at least one serving cell of a serving RAT, wherein the serving base station supports the at least one serving cell.

11. The apparatus of claim 9, further comprising means for defining the first set of UEs and the second set of UEs based at least in part on concurrent services running on the first set of UEs and the second set of UEs.

12. The apparatus of claim 9, further comprising means for defining the first set of UEs and the second set of UEs based at least in part on a category of each of the UEs in the first set of UEs and each of the UEs in the second set of UEs.

13. The apparatus of claim 9, further comprising means for defining the first set of UEs and the second set of UEs based at least in part on a quality of service (QoS) profile of the UEs in the first set of UEs and the second set of UEs or applications running on the UEs in the first set of UEs and the second set of UEs.

14. An apparatus for wireless communication, comprising:
a memory;
a transceiver configured for wireless communication; and
at least one processor coupled to the memory and the transceiver, the at least one processor configured:
to configure a first set of UEs (user equipments), served by a serving base station, with a first IRAT measurement reporting threshold (inter-radio access technology measurement reporting threshold); and
to configure a second set of UEs, served at the serving base station, with a second IRAT measurement reporting threshold that differs from the first IRAT measurement reporting threshold when a number of UEs served by the serving base station exceeds a congestion threshold; the congestion threshold, the first IRAT measurement reporting threshold, and/or the second IRAT measurement reporting threshold being based at least in part on a capability of at least one target base station of a target RAT that supports at least one potential target cell to handle incoming IRAT handovers.

15. The apparatus of claim 14, in which the at least one processor is further configured to determine a number of UEs to include in the first set of UEs and/or a number of UEs to include in the second set of UEs based at least in part on a number of potential target cells overlaid with at least one serving cell of a serving RAT, wherein the serving base station supports the at least one serving cell.

16. The apparatus of claim 14, in which the at least one processor is further configured to define the first set of UEs and the second set of UEs based at least in part on services running on the first set of UEs and the second set of UEs.

17. The apparatus of claim 14, in which the at least one processor is further configured to define the first set of UEs and the second set of UEs based at least in part on a category of each of the UEs in the first set of UEs and each of the UEs in the second set of UEs.

18. The apparatus of claim 14, in which the at least one processor is further configured to define the first set of UEs and the second set of UEs based at least in part on a quality of service (QoS) profile of the UEs in the first set of UEs and the second set of UEs or applications running on the UEs in the first set of UEs and the second set of UEs.

19. The apparatus of claim 14, in which the at least one processor is further configured to define the first set of UEs and the second set of UEs based at least in part on whether the target RAT supports all or partial concurrent services running on the first set of UEs and the second set of UEs.

20. The apparatus of claim 14, in which the at least one processor is further configured to define the first set of UEs and the second set of UEs based at least in part on a connection setup or connection status of the UEs in the first set of UEs and the second set of UEs.

21. The apparatus of claim 14, in which the at least one processor is further configured to determine the number of UEs that could be served by the target RAT based at least in part on communication between the serving base station and a potential target base station.

22. A non-transitory computer-readable medium having non-transitory program code recorded thereon, the program code comprising:
program code to configure a first set of UEs (user equipments), served by a serving base station, with a first IRAT measurement reporting threshold (inter-radio access technology measurement reporting threshold); and
program code to configure a second set of UEs, served at the serving base station, with a second IRAT measurement reporting threshold that differs from the first IRAT measurement reporting threshold when a number of UEs served by the serving base station exceeds a congestion threshold; the congestion threshold, the first IRAT measurement reporting threshold, and/or the second IRAT measurement reporting threshold being based at least in part on a capability of at least one target base station of a target RAT supporting at least one potential target cell to handle incoming IRAT handovers.

23. The computer-readable medium of claim 22, in which the program code is further configured to determine a number of UEs to include in the first set of UEs and/or a number of UEs to include in the second set of UEs based at least in part on a number of potential target cells overlaid with at least one serving cell of a serving RAT, wherein the serving base station supports the at least one serving cell.

24. The computer-readable medium of claim 22, in which the program code is further configured to define the first set of UEs and the second set of UEs based at least in part on concurrent services running on the first set of UEs and the second set of UEs.

25. The computer-readable medium of claim 22, in which the program code is further configured to define the first set of UEs and the second set of UEs based at least in part on a category of each of the UEs in the first set of UEs and each of the UEs in the second set of UEs.

26. The computer-readable medium of claim 22, in which the program code is further configured to define the first set of UEs and the second set of UEs based at least in part on a quality of service (QoS) profile of the UEs in the first set of UEs and the second set of UEs or applications running on the UEs in the first set of UEs and the second set of UEs.
